(19) United States
(12) Patent Application Publication
(10) Pub. No.: US 2014/0267432 A1
(43) Pub. Date: Sep. 18, 2014

(54) METHOD TO SELECT APPROPRIATE WINDOW SIZE FOR LOCAL IMAGE PROCESSING

(71) Applicant: SONY CORPORATION, Tokyo (JP)

(72) Inventors: Xiaogang Dong, Boyds, MD (US); Farhan A. Baqai, Fremont, CA (US); Nobuyuki Matsushita, Kanagawa (JP); Kenichi Nishio, Yokohama (JP)

(73) Assignee: SONY CORPORATION, Tokyo (JP)

(21) Appl. No.: 13/797,296

(22) Filed: Mar. 12, 2013

(51) Int. Cl. G06T 3/40

(52) U.S. Cl. CPC G06T 3/40
USPC 345/660

(57) ABSTRACT

A method to select an appropriate window size for local image processing uses two window sizes: a very large but impractical size and a small and practical size. Two images are generated for the desired image processing under both window sizes. The difference of these two images eliminates common non-linear nature of the local image processing and only contains low-frequency artifacts generated under a smaller window size. By taking the Fourier transform of the difference image, an approximated noise spectrum of low-frequency artifacts introduced by the small and practical window size is able to be observed. Alternatively, a frequency analysis of the smaller window size is able to be conducted by calculating the difference of cross-correlation functions and noise spectra under the same two window sizes. An appropriate window size is able to be selected based on such frequency analysis.

### FIELD OF THE INVENTION

The present invention relates to the field of image processing. More specifically, the present invention relates to selecting window sizes for image processing.

### BACKGROUND OF THE INVENTION

Selection of window size is a critical issue for local image processing, particularly in an image processing pipeline of digital cameras, printers, scanners and other devices. A window size too small will cause undesired low-frequency artifacts, and a window size too large will factor into production costs.

### SUMMARY OF THE INVENTION

Methods to select an appropriate window size for local image processing uses two window sizes: a very large but impractical size and a small and practical size. Two images are generated for the desired image processing under both window sizes. The difference of these two images eliminates common non-linear nature of the local image processing and only contains low-frequency artifacts generated under a smaller window size. By taking the Fourier transform of the difference image, an approximated noise spectrum of low-frequency artifacts introduced by the small and practical window size is able to be observed. Alternatively, a frequency analysis of the smaller window size is able to be conducted by calculating the difference of cross-correlation functions and noise spectra under the same two window sizes. An appropriate window size is able to be selected based on such frequency analyses.

In one aspect, a method programmed in a memory of a device comprises determining a plurality of window sizes, calculating a plurality of cross correlation functions between input and output images under the plurality of window sizes, calculating a plurality of noise spectra by taking a transform of the plurality of cross correlation functions, performing frequency analysis on a difference of the plurality of noise spectra under the plurality of window sizes and selecting a window size based on the frequency analysis. The plurality of window sizes comprises a first window size and a second window size wherein the first window size is significantly larger than the second window size. The method further comprises assuming there are no low-frequency artifacts in the first window size. The plurality of cross correlation functions comprises a first cross correlation function calculated under the first window size and a second cross correlation function under the second window size. The transform is a fast Fourier transform. The plurality of noise spectra comprises a first noise spectrum transformed from the first cross correlation function and a second noise spectrum transformed from the second cross correlation function. The noise spectrum is a square root of a power spectrum. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, a method programmed in a memory of a device comprises determining a plurality of window sizes, generating a plurality of images using the plurality of window sizes, generating a difference image between the plurality of images, taking a transform of the difference image to generate a noise spectrum, performing frequency analysis of the noise spectrum and selecting a window size based on the frequency analysis. The plurality of window sizes comprises a first window size and a second window size wherein the first window size is significantly larger than the second window size. The method further comprises assuming there are no low-frequency artifacts in the first window size. The plurality of images comprises a first image generated under a first window size and a second image generated under a second window size. The transform is a fast Fourier transform. The noise spectrum is a square root of a power spectrum. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, an apparatus comprises a sensor for acquiring an image, a memory for storing an application, the application for determining a plurality of window sizes, calculating a plurality of cross correlation functions between input and output images under the plurality of window sizes, calculating a plurality of noise spectra by taking a transform of the plurality of cross correlation functions, performing frequency analysis on a difference of the plurality of noise spectra under the plurality of window sizes and selecting a window size based on the frequency analysis and a processing component coupled to the memory, the processing component configured for processing the application. The plurality of window sizes comprises a first window size and a second window size wherein the first window size is significantly larger than the second window size. The apparatus further comprises assuming there are no low-frequency artifacts in the first window size. The plurality of cross correlation functions comprises a first cross correlation function calculated under the first window size and a second cross correlation function under the second window size. The transform is a fast Fourier transform. The plurality of noise spectra comprises a first noise spectrum transformed from the first cross correlation function and a second noise spectrum transformed from the second cross correlation function. The noise spectrum is a square root of a power spectrum.

In another aspect, an apparatus comprises a sensor for acquiring an image, a memory for storing an application, the application for determining a plurality of window sizes, generating a plurality of images using the plurality of window sizes, generating a difference image between the plurality of images, taking a transform of the difference image to generate a noise spectrum, performing frequency analysis of the noise spectrum and selecting a window size based on the frequency analysis and a processing component coupled to the memory, the processing component configured for processing the application. The plurality of window sizes comprises a first window size and a second window size wherein the first window size is significantly larger than the second window size. The apparatus further comprising assuming there are no low-frequency artifacts in the first window size. The plurality of images comprises a first image generated under a first window size and a second image generated under a second window size. The transform is a fast Fourier transform. The noise spectrum is a square root of a power spectrum.

### BRIEF DESCRIPTION OF THE DRAWINGS

FIG. 1 illustrates vertical cross correlation functions between input and output images and vertical noise spectra under two different window sizes using algorithm 1 according to some embodiments.

FIG. 2 illustrates the difference of vertical noise spectra under different window sizes using algorithm 1 according to some embodiments.

FIG. 3 illustrates the results of vertical FFT applied to the difference images under different window sizes using algorithm 1 according to some embodiments.

FIG. 4 illustrates vertical cross correlation functions between input and output images and vertical noise spectra under two different window sizes using algorithm 2 according to some embodiments.

FIG. 5 illustrates the difference of vertical noise spectra under different window sizes using algorithm 2 according to some embodiments.

FIG. 6 illustrates the results of vertical FFT applied to the difference images under different window sizes using algorithm 2 according to some embodiments.

FIG. 7 illustrates a flowchart of a method of determining a frequency response using multiple windows according to some embodiments.

FIG. 8 illustrates a flowchart of another method of determining a frequency response using multiple windows according to some embodiments.

FIG. 9 illustrates a block diagram of an exemplary computing device configured to implement the window size selection methods according to some embodiments.

### DETAILED DESCRIPTION OF THE PREFERRED EMBODIMENT

A direct frequency analysis generally is not able to be conducted for window size selection since many local image processing techniques are non-linear. In order to overcome such an obstacle, the cross-correlation functions between the input signal and the output signal of a desired local image processing technique are analyzed. A Fourier transform of the cross-correlation function is a noise spectrum (square root of power spectrum) of the desired local image processing technique in a stochastic sense.

The techniques described herein use two window sizes: a very large but impractical size and a small and practical size. Two images are generated for the desired image processing under both window sizes. It is assumed there are no low-frequency artifacts under the larger window size for the desired image processing. The difference of these two images eliminates common non-linear nature of the local image processing and only contains low-frequency artifacts generated under a smaller window size. A frequency analysis of the smaller window size is able to be conducted either by calculating the difference of cross-correlation functions and noise spectra under the two window sizes or by calculating the noise spectrum of the difference of two output images generated under the two window sizes. An appropriate window size is able to be selected based on such frequency analyses.

In some embodiments, cross correlation functions are calculated between noise in smooth regions of input images and noise in smooth regions of output images. For a large window size w1, the cross correlation function is calculated and then the corresponding noise spectrum (square root of power spectrum) is calculated. Then, a practical window size w2 (e.g., smaller than the large window size) is selected for analysis. The cross correlation function and noise spectrum are calculated for the window size w2. The difference between the noise spectrum of w1 and the noise spectrum of w2 is the frequency response of low-frequency artifacts introduced into the output images when a smaller window size w2 is applied.

In some embodiments, the cross correlation functions between noise in input images and those in output images are very difficult to calculate. Instead of performing the method above, a large window size w1 is selected, and an output image for a particular input image is generated. Then, a practical window size w2 (e.g., smaller than the large window size) is selected, and an output image is generated for the same input image. A large smooth region in the output image is selected, and a transform (e.g., Fourier Transform or FFT) is performed on the difference of the two images. The result of such transform is the frequency response of low-frequency artifacts introduced into the output images when a smaller window size w2 is applied.

Two algorithms are utilized for illustration purposes. Algorithm 1 is described in U.S. patent Ser. No. 12/931,962, filed on Feb. 15, 2011, titled “AN IMPROVED METHOD TO MEASURE LOCAL IMAGE SIMILARITY AND ITS APPLICATION IN IMAGE PROCESSING,” which is hereby incorporated by reference in its entirety for all purposes. Algorithm 2 is described in U.S. patent Ser. No. 13/065,729, filed on Mar. 29, 2011, titled “WAVELET TRANSFORM ON INCOMPLETE IMAGE DATA AN ITS APPLICATIONS IN IMAGE PROCESSING,” which is hereby incorporated by reference in its entirety for all purposes.

For simplicity of illustration, 1 dimensional frequency analysis is performed on 2 dimensional images, although the methods are able to be implemented in more than 1 dimension.

In more detail, horizontal sizes of windows are selected large enough not to produce any significant low-frequency artifacts, and frequency analysis is performed on vertical sizes of windows. In the following description, many terminologies such as cross correlation function, power spectrum, and window size, refer to their corresponding vertical counterparts.

FIG. 1 illustrates vertical cross correlation functions between input and output images, and vertical noise spectra under two different window sizes using algorithm 1 according to some embodiments. The frequency response in the lower graph is the square root of the power spectrum (also referred to as the noise spectrum). A large window size of 37×37 and a small window size of 9×37 are used.

When the window size is 37×37, the vertical cross correlation function has equal positive value from 0 to 36 and 0 elsewhere. When the window size is 9×37, the vertical cross correlation function has equal positive value from 0 to 8 and 0 elsewhere. The corresponding frequency responses of the cross correlation functions (also referred to as the noise spectrum) are also illustrated. Equal values in spatial domain mean that each pixel has the same probability being involved in filtering. Larger values in frequency domain mean that signals at these frequencies have higher probability to survive after filtering. In a particular window operation, the frequency response is able to be far different.

Differences of noise spectra under different pluralities of window sizes are shown in FIG. 2. The large window size is fixed at 37×37, and a smaller window size, such as 9×37, 13×37, 17×37 and 21×37 with algorithm 1 is able to be used.

Differences of the noise spectra show that the smaller vertical window gives higher low-frequency residues in the spatial domain. By performing analysis on the differences of noise spectra, an appropriate window size of algorithm 1 is able to be selected.

In some embodiments, the cross correlation functions between noise in input images and those in output images are very difficult to calculate. Instead of performing the method above, a particular input image is selected and an output image is produced using algorithm 1 under a large window size 37×37. For the same input image, an output image using algorithm 1 under a smaller window size, such as 9×37, 13×37, 17×37 and 21×37. Some large smooth region is selected in both output images. The difference images of the selected regions are generated, and then a Fast Fourier Transform (FFT) is taken of the difference images.

FIG. 3 illustrates the results of vertical FFT applied to the difference images under different window sizes using algorithm 1 according to some embodiments. Note that the results in FIG. 3 although somewhat unsmooth due to small sample sizes but resemble well with the noise spectra illustrated in FIG. 2. By analyzing the frequency response illustrated in FIG. 3, an appropriate window size of algorithm 1 can be also selected.

FIG. 4 illustrates cross correlation functions between input and output images and vertical noise spectra under two different window sizes using algorithm 2 according to some embodiments. The frequency response in the lower graph is the square root of the power spectrum (also referred to as the noise spectrum). A large window size of 29×29 and a small window size of 3×29 are used.

When the window size is 29×29, the vertical cross correlation function is an isosceles trapezoid from 0 to 36 and 0 elsewhere. When the window size is 3×29, the vertical cross correlation function is an isosceles trapezoid from 0 to 8 and 0 elsewhere. The corresponding frequency responses of the cross correlation functions (also referred to as the noise spectrum) are also illustrated. Larger value in spatial domain means that the corresponding pixel has a larger probability being involved in filtering. Larger values in frequency domain mean that signals at these frequencies have higher probability to survive after filtering. In a particular window operation, the frequency response is able to be far different.

Differences of noise spectra under different pluralities of window sizes are shown in FIG. 5. The large window size is fixed at 29×29 and a smaller window size, such as 3×29, 7×29, 11×29 and 15×29 with algorithm 2 are able to be used.

Differences of the noise spectra show that the smaller vertical window gives higher low-frequency residues in the spatial domain. By performing analysis on the differences of noise spectra, an appropriate window size of algorithm 2 is able to be selected.

In some embodiments, the cross correlation functions between noise in input images and those in output images are very difficult to calculate. Instead of performing the method above, a particular input image is selected and an output image is produced using algorithm 2 under a large window size 29×29. For the same input image, an output image using algorithm 2 under a smaller window size, such as 3×29, 7×29, 11×29 and 15×29. Some large smooth region is selected in both output images. The difference images of the selected regions are generated, and then a Fast Fourier Transform (FFT) is taken of the difference images. FIG. 6 illustrates the results of vertical FFT applied to the difference images under different pluralities of window sizes using algorithm 2 according to some embodiments. Note that the results in FIG. 6 although somewhat unsmooth due to small sample sizes but resemble well with the noise spectra illustrated in FIG. 5. By analyzing the frequency response illustrated in FIG. 6, an appropriate window size of algorithm 2 can be also selected.

FIG. 7 illustrates a flowchart of a method of determining a frequency response using multiple windows according to some embodiments. In the step 700, a large window size w1 is selected, and the cross correlation function is calculated for a large window size w1. In the step 702, the corresponding noise spectrum (square root of power spectrum) is calculated. In the step 704, a smaller window size w2 is selected, and the cross correlation function is calculated for a practical window size w2. In the step 706, the noise spectrum is calculated for the practical window size w2. In the step 708, a difference between the noise spectrum of w1 and w2 is determined. The difference between the noise spectrum of w1 and the noise spectrum of w2 is the frequency response of low-frequency artifacts introduced into the output images when a smaller window size w2 is applied. In some embodiments, more or fewer steps are implemented. In some embodiments, the order of the steps is modified.

FIG. 8 illustrates a flowchart of a method of determining a frequency response using multiple windows according to some embodiments. In some embodiments, the cross correlation functions between noise in input images and those in output images are very difficult to calculate. In the step 800, a large window size w1 is selected. In the step 802, an output image for a particular input image is generated. In the step 804, a practical window size w2 (e.g., smaller than the large window size) is selected. In the step 806, an output image is generated for the same input image. In the step 808, a large smooth region in the output images is selected, and a difference is determined. In the step 810, a transform (e.g., Fourier Transform or FFT) is performed on the difference of the two images. In some embodiments, more or fewer steps are implemented. In some embodiments, the order of the steps is modified.

In some embodiments, it is determined if the method of FIG. 7 is able to be implemented first, and if not (e.g., because the cross correlation function calculation's complexity exceeds a threshold), then the method of FIG. 8 is implemented.

FIG. 9 illustrates a block diagram of an exemplary computing device configured to implement the window size selection method according to some embodiments. The computing device 900 is able to be used to acquire, store, compute, process, communicate and/or display information such as images and videos. In general, a hardware structure suitable for implementing the computing device 900 includes a network interface 902, a memory 904, a processor 906, I/O device(s) 908, a bus 910 and a storage device 912. The choice of processor is not critical as long as a suitable processor with sufficient speed is chosen. The memory 904 is able to be any conventional computer memory known in the art. The storage device 912 is able to include a hard drive, CDROM, CDRW, DVD, DVDRW, flash memory card or any other storage device. The computing device 900 is able to include one or more network interfaces 902. An example of a network interface includes a network card connected to an Ethernet or other type of LAN. The I/O device(s) 908 are able to include one or more of the following: keyboard, mouse, monitor, display, printer, modem, touchscreen, button interface and other devices. Window size selection application(s) 930 used to perform the window size selection method are likely to be stored in the storage device 912 and memory 904 and processed as applications are typically processed. More or fewer components shown in FIG. 9 are able to be included in the computing device 900. In some embodiments, window size selection hardware 920 is included. Although the computing device 900 in FIG. 9 includes applications 930 and hardware 920 for the window size selection method, the window size selection method is able to be implemented on a computing device in hardware, firmware, software or any combination thereof. For example, in some embodiments, the window size selection applications 930 are programmed in a memory and executed using a processor. In another example, in some embodiments, the window size selection hardware 920 is programmed hardware logic including gates specifically designed to implement the window size selection method.

In some embodiments, the window size selection application(s) 930 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

To utilize the window size selection method, a user acquires a video/image such as on a digital camcorder, and while or after the content is acquired, the window size selection method automatically determines the appropriate window size for processing the image. The window size selection method occurs automatically without user involvement.

In operation, the window size selection method reduces the hardware complexity of an imaging system by using a much less computationally intensive window.

### Some Embodiments of a Method to Select Appropriate Window Size for Local Image Processing

1. A method programmed in a memory of a device comprising:
   a. determining a plurality of window sizes;
   b. calculating a plurality of cross correlation functions between input and output images under the plurality of window sizes;
   c. calculating a plurality of noise spectra by taking a transform of the plurality of cross correlation functions;
   d. performing frequency analysis on a difference of the plurality of noise spectra under the plurality of window sizes; and
   e. selecting a window size based on the frequency analysis.
2. The method of clause 1 wherein the plurality of window sizes comprises a first window size and a second window size wherein the first window size is significantly larger than the second window size.
3. The method of clause 2 further comprising assuming there are no low-frequency artifacts in the first window size.
4. The method of clause 1 wherein the plurality of cross correlation functions comprises a first cross correlation function calculated under the first window size and a second cross correlation function under the second window size.
5. The method of clause 1 wherein the transform is a fast Fourier transform.
6. The method of clause 1 wherein the plurality of noise spectra comprises a first noise spectrum transformed from the first cross correlation function and a second noise spectrum transformed from the second cross correlation function.
7. The method of clause 1 wherein the noise spectrum is a square root of a power spectrum.
8. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
9. A method programmed in a memory of a device comprising:

a. determining a plurality of window sizes;

b. generating a plurality of images using the plurality of window sizes;

c. generating a difference image between the plurality of images;

d. taking a transform of the difference image to generate a noise spectrum;

e. performing frequency analysis of the noise spectrum; and

f. selecting a window size based on the frequency analysis.
10. The method of clause 9 wherein the plurality of window sizes comprises a first window size and a second window size wherein the first window size is significantly larger than the second window size.
11. The method of clause 10 further comprising assuming there are no low-frequency artifacts in the first window size.
12. The method of clause 9 wherein the plurality of images comprises a first image generated under a first window size and a second image generated under a second window size.
13. The method of clause 9 wherein the transform is a fast Fourier transform.
14. The method of clause 9 wherein the noise spectrum is a square root of a power spectrum.
15. The method of clause 9 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
16. An apparatus comprising:
   a. a sensor for acquiring an image;
   b. a memory for storing an application, the application for:
      i. determining a plurality of window sizes;
      ii. calculating a plurality of cross correlation functions between input and output images under the plurality of window sizes;
      iii. calculating a plurality of noise spectra by taking a transform of the plurality of cross correlation functions;
      iv. performing frequency analysis on a difference of the plurality of noise spectra under the plurality of window sizes; and
      v. selecting a window size based on the frequency analysis; and
   c. a processing component coupled to the memory, the processing component configured for processing the application.
17. The apparatus of clause 16 wherein the plurality of window sizes comprises a first window size and a second window size wherein the first window size is significantly larger than the second window size.
18. The apparatus of clause 17 further comprising assuming there are no low-frequency artifacts in the first window size.
19. The apparatus of clause 16 wherein the plurality of cross correlation functions comprises a first cross correlation function calculated under the first window size and a second cross correlation function under the second window size.
20. The apparatus of clause 16 wherein the transform is a fast Fourier transform.
21. The apparatus of clause 16 wherein the plurality of noise spectra comprises a first noise spectrum transformed from the first cross correlation function and a second noise spectrum transformed from the second cross correlation function.
22. The apparatus of clause 16 wherein the noise spectrum is a square root of a power spectrum.
23. An apparatus comprising:
   a. a sensor for acquiring an image;
   b. a memory for storing an application, the application for:
      i. determining a plurality of window sizes;
      ii. generating a plurality of images using the plurality of window sizes;
      iii. generating a difference image between the plurality of images;
      iv. taking a transform of the difference image to generate a noise spectrum;
      v. performing frequency analysis of the noise spectrum; and
      vi. selecting a window size based on the frequency analysis; and
   c. a processing component coupled to the memory, the processing component configured for processing the application.
24. The apparatus of clause 23 wherein the plurality of window sizes comprises a first window size and a second window size wherein the first window size is significantly larger than the second window size.
25. The apparatus of clause 24 further comprising assuming there are no low-frequency artifacts in the first window size.
26. The apparatus of clause 23 wherein the plurality of images comprises a first image generated under a first window size and a second image generated under a second window size.
27. The apparatus of clause 23 wherein the transform is a fast Fourier transform.
28. The apparatus of clause 23 wherein the noise spectrum is a square root of a power spectrum.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a memory of a device comprising:
a. determining a plurality of window sizes;
b. calculating a plurality of cross correlation functions between input and output images under the plurality of window sizes;
c. calculating a plurality of noise spectra by taking a transform of the plurality of cross correlation functions;
d. performing frequency analysis on a difference of the plurality of noise spectra under the plurality of window sizes; and
e. selecting a window size based on the frequency analysis.

2. The method of claim 1 wherein the plurality of window sizes comprises a first window size and a second window size wherein the first window size is significantly larger than the second window size.

3. The method of claim 2 further comprising assuming there are no low-frequency artifacts in the first window size.

4. The method of claim 1 wherein the plurality of cross correlation functions comprises a first cross correlation function calculated under the first window size and a second cross correlation function under the second window size.

5. The method of claim 1 wherein the transform is a fast Fourier transform.

6. The method of claim 1 wherein the plurality of noise spectra comprises a first noise spectrum transformed from the first cross correlation function and a second noise spectrum transformed from the second cross correlation function.

7. The method of claim 1 wherein the noise spectrum is a square root of a power spectrum.

8. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

9. A method programmed in a memory of a device comprising:
a. determining a plurality of window sizes;
b. generating a plurality of images using the plurality of window sizes;
c. generating a difference image between the plurality of images;
d. taking a transform of the difference image to generate a noise spectrum;
e. performing frequency analysis of the noise spectrum; and
f. selecting a window size based on the frequency analysis.

10. The method of claim 9 wherein the plurality of window sizes comprises a first window size and a second window size wherein the first window size is significantly larger than the second window size.

11. The method of claim 10 further comprising assuming there are no low-frequency artifacts in the first window size.

12. The method of claim 9 wherein the plurality of images comprises a first image generated under a first window size and a second image generated under a second window size.

13. The method of claim 9 wherein the transform is a fast Fourier transform.

14. The method of claim 9 wherein the noise spectrum is a square root of a power spectrum.

15. The method of claim 9 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

16. An apparatus comprising:
a. a sensor for acquiring an image;
b. a memory for storing an application, the application for:
i. determining a plurality of window sizes;
ii. calculating a plurality of cross correlation functions between input and output images under the plurality of window sizes;
iii. calculating a plurality of noise spectra by taking a transform of the plurality of cross correlation functions;
iv. performing frequency analysis on a difference of the plurality of noise spectra under the plurality of window sizes; and
v. selecting a window size based on the frequency analysis; and
c. a processing component coupled to the memory, the processing component configured for processing the application.

17. The apparatus of claim 16 wherein the plurality of window sizes comprises a first window size and a second window size wherein the first window size is significantly larger than the second window size.

18. The apparatus of claim 17 further comprising assuming there are no low-frequency artifacts in the first window size.

19. The apparatus of claim 16 wherein the plurality of cross correlation functions comprises a first cross correlation function calculated under the first window size and a second cross correlation function under the second window size.

20. The apparatus of claim 16 wherein the transform is a fast Fourier transform.

21. The apparatus of claim 16 wherein the plurality of noise spectra comprises a first noise spectrum transformed from the first cross correlation function and a second noise spectrum transformed from the second cross correlation function.

22. The apparatus of claim 16 wherein the noise spectrum is a square root of a power spectrum.

23. An apparatus comprising:
a. a sensor for acquiring an image;
b. a memory for storing an application, the application for:
i. determining a plurality of window sizes;
ii. generating a plurality of images using the plurality of window sizes;
iii. generating a difference image between the plurality of images;
iv. taking a transform of the difference image to generate a noise spectrum;
v. performing frequency analysis of the noise spectrum; and
vi. selecting a window size based on the frequency analysis; and
c. a processing component coupled to the memory, the processing component configured for processing the application.

24. The apparatus of claim 23 wherein the plurality of window sizes comprises a first window size and a second window size wherein the first window size is significantly larger than the second window size.

25. The apparatus of claim 24 further comprising assuming there are no low-frequency artifacts in the first window size.

26. The apparatus of claim 23 wherein the plurality of images comprises a first image generated under a first window size and a second image generated under a second window size.

27. The apparatus of claim 23 wherein the transform is a fast Fourier transform.

28. The apparatus of claim 23 wherein the noise spectrum is a square root of a power spectrum.
